(19) United States
(12) Patent Application Publication
(10) Pub. No.: US 2024/0106726 A1
(43) Pub. Date: Mar. 28, 2024

(54) APPARATUS FOR PROCESSING PACKET USING DEEP PACKET INSPECTION INFORMATION AND METHOD THEREOF

(71) Applicant: SYSMATE CO., LTD., Daejeon (KR)

(72) Inventors: Byungkon SONG, Seoul (KR); Junsung KIM, Daejeon (KR); Yookyoung LEE, Sejong-si (KR); Ganho CHOI, Daejeon (KR)

(73) Assignee: SYSMATE CO., LTD., Daejeon (KR)

(21) Appl. No.: 17/980,502

(22) Filed: Nov. 3, 2022

(30) Foreign Application Priority Data
Sep. 26, 2022 (KR) 10-2022-0121449

(51) Int. Cl. H04L 43/028

(52) U.S. Cl. CPC H04L 43/028

(57) ABSTRACT

Disclosed are a packet processing apparatus using deep packet information and a method thereof. A network system according to an embodiment includes a packet processing apparatus configured to transmit a packet to a packet inspection apparatus, to receive and parse a packet in which deep packet information is tagged from the packet inspection apparatus, and to switch the packet according to the parsed deep packet information, and the packet inspection apparatus configured to perform deep-inspection on the packet received from the packet processing apparatus and to tag the deep packet information in a head room area of the packet.

### CROSS-REFERENCE TO RELATED APPLICATION(S)

This application claims priority from Korean Patent Application No. 10-2022-0121449, filed on Sep. 26, 2022, in the Korean Intellectual Property Office, the disclosure of which is incorporated herein by reference in its entirety.

### BACKGROUND

### 1. Field

The present disclosure relates to packet processing technology.

### 2. Description of Related Art

In general, a packet processing apparatus such as a switch is a device that performs switching or routing by matching header field information of L2 to L4 layers to determine a destination port. The switch cannot perform deep packet analysis, which requires tracking of session state information, and is specialized in the performance of switching a received packet.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an embodiment, disclosed are a packet processing apparatus capable of minimizing copy overhead and providing an extended switching function when tagging deep packet information to forward deep packet information between the packet processing apparatus and a packet inspection apparatus and a method thereof.

A network system according to an embodiment includes a packet processing apparatus configured to transmit a packet to a packet inspection apparatus, receive and parse a packet in which deep packet information is tagged from the packet inspection apparatus, and to switch the packet according to the parsed deep packet information, and the packet inspection apparatus configured to perform deep-inspection on the packet received from the packet processing apparatus and to tag the deep packet information in a head room area of the packet.

The deep packet information may include an application identifier, a user identifier, or location information.

The packet inspection apparatus may insert a magic number and a checksum in the head room area as a tag along with the deep packet information.

The packet processing apparatus may distinguish a general Ethernet packet and a tagged Ethernet packet based on information indicating whether the magic number matches the checksum.

The packet processing apparatus may include a transceiver configured to transmit or receive the packet, and a processor connected to the transceiver, wherein the processor may transmit, when the packet is received, the received packet to the packet inspection apparatus through the transceiver, may receive a packet in which the deep packet information is tagged through the transceiver to parse the head room area, and may switch the packet according to the deep packet information parsed in the head room area.

A packet processing method using a packet processing apparatus according to another embodiment includes receiving a packet and transmitting the received packet to a packet inspection apparatus, receiving a packet in which deep packet information is tagged in a head room area of the packet from the packet inspection apparatus and parsing the packet, and switching the packet according to the parsed deep packet information.

In addition, the packet processing method may further include distinguishing a general Ethernet packet and a tagged Ethernet packet based on information indicating whether a magic number and a checksum, which are inserted in the head room area as a tag along with the deep packet information, match each other.

A packet inspection method using a packet inspection apparatus according to another embodiment includes receiving a packet from a packet processing apparatus, performing deep-inspection on the received packet and tagging deep packet information in a head room area of the packet, and transmitting a packet in which the deep packet information is tagged to the packet processing apparatus.

The tagging may include inserting the magic number and the checksum in the head room area as the tag along with the deep packet information.

According to a packet processing apparatus and a method thereof according to the present disclosure, a packet can be switched using deep packet information tagged in a head room area of the packet.

Accordingly, from the point of view of the packet processing apparatus, since the deep packet information is present in the head room area of the packet, parsing is easy, and a checksum acceleration engine can check tag validity. When the packet processing apparatus is a programmable switch, an L7 switching function using the deep packet information can be provided in addition to a switching function using L2 to L4 header information supported by the programmable switch.

From the point of view of the packet inspection apparatus, a header (memory) copy overhead can be minimized by tagging the deep packet information using the head room area of the received packet.

Other features and aspects will be apparent from the following detailed description, the drawings, and the claims.

### BRIEF DESCRIPTION OF THE DRAWINGS

FIG. 1 is a diagram illustrating a configuration of a network system according to an embodiment of the present disclosure.

FIG. 2 is a diagram illustrating a configuration of a packet processing apparatus according to an embodiment of the present disclosure.

FIG. 3 is a diagram illustrating a position, at which specific information is inserted, in a general Ethernet packet.

FIG. 4 is a diagram illustrating a position, at which deep packet information is inserted, in an Ethernet packet according to an embodiment of the present disclosure.

FIG. 5 is a diagram illustrating a network packet management structure according to an embodiment of the present disclosure.

FIG. 6 is a diagram illustrating a packet structure in which deep packet information is tagged according to an embodiment of the present disclosure.

FIG. 7 is a flowchart illustrating operations between a packet processing apparatus and a packet inspection apparatus according to the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Advantages and features of the present disclosure, and a method of achieving them will become apparent with reference to embodiments described below in detail, together with the accompanying drawings. However, the present disclosure is not limited to the embodiments described below, and may be implemented in various different forms. These embodiments are provided only to make the disclosure of the present disclosure complete and to fully inform the scope of the present invention to those skilled in the art, and the present disclosure is only defined by the scope of the claims. Like reference numerals refer to like elements throughout the specification.

In the description below, when it is determined that detailed descriptions of related well-known functions unnecessarily obscure the gist of the present disclosure, detailed descriptions thereof will be omitted. Some terms described below are defined by considering functions in the present disclosure and meanings may vary depending on, for example, a user or operator's intentions or customs. Therefore, the meanings of terms should be interpreted based on the scope throughout this specification.

Hereinafter, embodiments of the present disclosure will be described in detail with reference to the accompanying drawings. However, the embodiments of the present disclosure illustrated below may be modified in various other forms, and the scope of the present disclosure is not limited to the embodiments described below. The embodiments of the present disclosure are provided to more completely explain the present disclosure to those of ordinary skill in the art to which the present disclosure pertains.

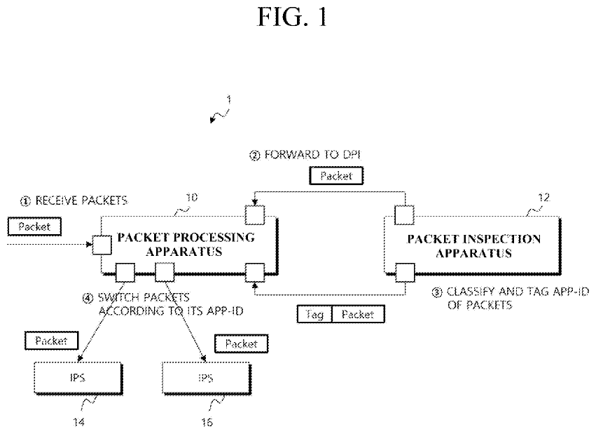

FIG. 1 is a diagram illustrating a configuration of a network system according to an embodiment of the present disclosure.

Referring to FIG. 1, a network system 1 includes a packet processing apparatus 10 and a packet inspection apparatus 12.

The packet processing apparatus 10 may be a network device such as a switch In this case, the switch is a programmable switch, and may be a switch used in software-defined networking (SDN, hereinafter referred to as “SDN”). SDN is one approach to information technology (IT) infrastructure that abstracts networking resources into a virtualized system. SDN separates a network forwarding function from a network control function to establish a centrally managed and programmable network. SDN allows an IT operation team to control network traffic in complex networking topology through a centralized panel, instead of manually processing each network device.

As the packet processing apparatus 10, an application specific integrated circuit (ASIC)-based programmable SDN switch is a device for performing switching or routing by matching header field information of L2 to L4 layers to determine a destination port. The ASIC-based programmable SDN switch is implemented as a chipset that supports a high-speed packet switching function from 3.2 to 12.8 Tbps by receiving high-speed lines of 100 to 400 GbE.

The packet processing apparatus 10, such as a high-speed programmable SDN switch, cannot perform deep packet analysis, which requires tracking of session state information, and is specialized in the performance of switching a received packet. Accordingly, when the packet processing apparatus 10 wants to switch a packet using deep packet information such as an application, a user, or location information, the packet inspection apparatus 12 performs a deep packet inspection (DPI) function in conjunction with the packet processing apparatus 10, and then transmits deep packet information to the packet processing apparatus 10. Here, the packet processing apparatus 10 switches the received packet using the deep packet information. The deep packet information is information generated as a result of deep inspection of a packet using the DPI function, and may include an application identifier, a user identifier, or location information.

Hereinafter, operations between the packet processing apparatus 10 and the packet inspection apparatus 12 will be described below.

When the packet processing apparatus 10 receives packets (1. Receive packets), the packet processing apparatus 10 transmits the packets to the packet inspection apparatus 12 (2. Forward to DPI). Subsequent, the packet inspection apparatus 12 classifies the packets and tags the deep packet information, for example, an application identifier (app-ID), to the packets (3. Classify and tag app-ID of packets), and then transmits the packets in which the deep packet information is tagged to the packet processing apparatus 10 (4. Switch packets according to its app-ID). The packet processing apparatus 10 switches the packets according to the deep packet information, for example, an application identifier (app-ID), to security devices. The security devices may be, for example, an intrusion prevention system (IPS) 14, a data loss prevention (DLP) system 16, or the like.

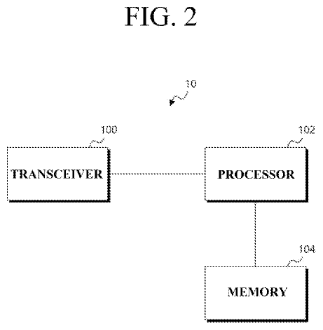

FIG. 2 is a diagram illustrating a configuration of a packet processing apparatus according to an embodiment of the present disclosure.

Referring to FIG. 2, the packet processing apparatus 10 includes a transceiver 100, a processor 102, and a memory 104.

The transceiver 100 transmits and receives packets.

The processor 102 is connected to the transceiver 100 and transmits, upon receiving a packet, the received packet to the packet inspection apparatus 12 through the transceiver 100. When the packet inspection apparatus 12 inspects the received packet and tags the deep packet information in the head room area of the packet, the processor 102 receives the packet in which the deep packet information is tagged through the transceiver 100 to parse the head room area of the packet, and switches the packet according to the deep packet information parsed in the head room area.

A checksum acceleration engine of the processor 102 may classify a general Ethernet packet and a tagged Ethernet packet based on information indicating whether a tagged magic number (Magic Num) matches a checksum.

The memory 104 stores information processed through the processor 102 or information necessary for processing.

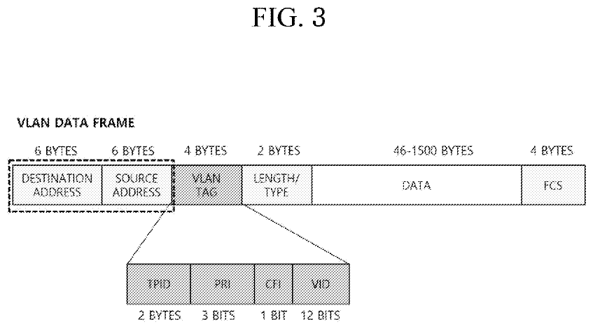

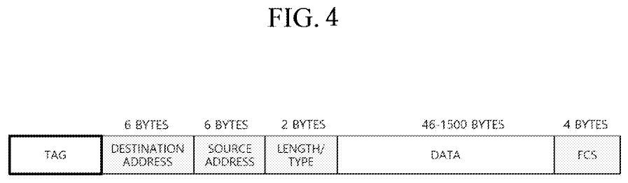

FIG. 3 is a diagram illustrating a position, at which specific information is inserted, in a general Ethernet packet and FIG. 4 is a diagram illustrating a position, at which deep packet information is inserted, in an Ethernet packet according to an embodiment of the present disclosure.

Referring to FIG. 3, as a method of inserting specific information into an Ethernet packet, there is a method of inserting an option field of a packet header in the middle of the packet, such as a tag virtual local area network (VLAN) or IP option. The VLAN and the IP option are located in the middle of the packet, and since the VLAN and IP option should be inserted in the middle of the packet, a packet processing load for high-speed interfaces of 100 to 400 GbE occurs due to header overhead and memory copy.

On the contrary, referring to FIG. 4, the packet inspection apparatus according to the embodiment inserts the deep packet information as a tag in the head room area, which is a front portion of the Ethernet packet. Accordingly, it is possible to improve the tagging (memory copy) speed of the deep packet information and minimize the memory copy of the packet.

Since the packet processing apparatus parses the deep packet information inserted in the head room area corresponding to the front portion of the packet, the packet processing apparatus has the advantage of parsing the deep packet information in the same manner as the conventional method using header information. Furthermore, the packet processing apparatus may distinguish the general Ethernet packet and the tagged Ethernet packet using the deep packet information.

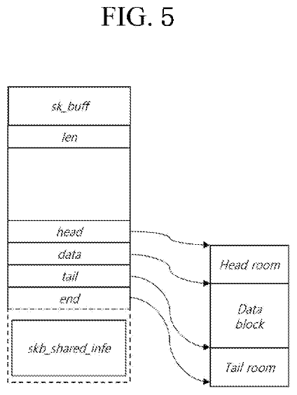

FIG. 5 is a diagram illustrating a network packet management structure according to an embodiment of the present disclosure.

Referring to FIG. 5, a sk_buff structure, which is a structure for managing network packets, includes a head room, a tail room, and a data block area containing actual data. Head, data, tail, and end variables are used to indicate the location of each area. Head to data corresponds to the head room, data to tail corresponds to the data block, and tail to end corresponds to the tail room.

The packet inspection apparatus according to the embodiment can minimize the memory copy of the packet by tagging the deep packet information in the head room of the packet.

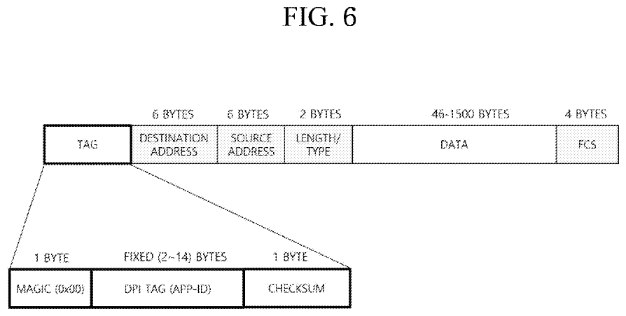

FIG. 6 is a diagram illustrating a packet structure in which deep packet information is tagged according to an embodiment of the present disclosure.

Referring to FIG. 6, the packet inspection apparatus inserts a tag into a head room area of an Ethernet packet in the order of a magic number, deep packet information (DPI tag), and checksum. The deep packet information (DPI tag) may be an application identifier (App-ID). The magic number (Magic Num) may have a size of 1 byte, the deep packet information (DPI tag) may have a size of 2 to 14 bytes, and the checksum may have a size of 1 byte.

A receiver may distinguish the Ethernet packet containing the deep packet information and the general Ethernet packet based on information indicating whether the magic number matches the checksum. The application identifier may be replaced with a user identifier, location information, or the like.

According to the above-described configuration, there are the following advantages from the point of view of the packet processing apparatus and the packet inspection apparatus.

From the point of view of the packet processing apparatus, since the deep packet information is present in the head room area of the packet, parsing is easy, and a checksum acceleration engine may check tag validity. When the packet processing apparatus is a programmable switch, an L7 switching function using the deep packet information may be provided in addition to a switching function using L2 to L4 header information supported by the programmable switch.

From the point of view of the packet inspection apparatus, header (memory) copy overhead can be minimized by tagging the deep packet information using the head room area of the received packet.

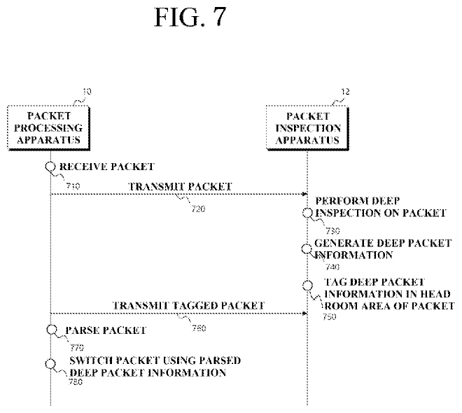

FIG. 7 is a flowchart illustrating operations between a packet processing apparatus and a packet inspection apparatus according to the present disclosure.

Referring to FIG. 7, when receiving a packet in operation 710, the packet processing apparatus 10 forwards the received packet to the packet inspection apparatus 12 in operation 720.

The packet inspection apparatus 12 performs a deep inspection on the received packet in operation 730, generates deep packet information according to the deep inspection result in operation 740, tags the generated deep packet information in the head room area of the packet in operation 750, and transmits the tagged packet to the packet processing apparatus 10 in operation 760.

The packet processing apparatus 10 parses the packet in which the deep packet information is tagged in the head room area of the packet in operation 770, and switches the packet according to the parsed deep packet information in operation 780.

Furthermore, the packet processing apparatus 10 may distinguish a general Ethernet packet and a tagged Ethernet packet based on information indicating whether the checksum matches the magic number inserted in the head room area along with the deep packet information.

So far, with respect to the present disclosure, embodiments have been described. Those of ordinary skill in the art to which the present disclosure pertains will understand that the present disclosure can be implemented in a modified form without departing from the essential characteristics of the present disclosure. Therefore, the disclosed embodiments are to be considered in an illustrative rather than a restrictive sense. The scope of the present disclosure is indicated in the claims rather than the above description, and all differences in the scope equivalent thereto should be construed as being included in the present disclosure.

What is claimed is:

1. A network system comprising:
a packet processing apparatus configured to transmit a packet to a packet inspection apparatus, receive and parse a packet in which deep packet information is tagged from the packet inspection apparatus, and switch the packet according to the parsed deep packet information; and
the packet inspection apparatus configured to perform deep-inspection on the packet received from the packet processing apparatus and tag the deep packet information in a head room area of the packet.

2. The network system of claim 1, wherein the deep packet information includes an application identifier, a user identifier, or location information.

3. The network system of claim 1, wherein the packet inspection apparatus inserts a magic number and a checksum in the head room area as a tag along with the deep packet information.

4. The network system of claim 1, wherein the packet processing apparatus distinguishes a general Ethernet packet and a tagged Ethernet packet based on information indicating whether a magic number matches a checksum.

5. The network system of claim 1, wherein the packet processing apparatus includes:
a transceiver configured to transmit or receive the packet; and
a processor connected to the transceiver,
wherein the processor transmits, when the packet is received, the received packet to the packet inspection apparatus through the transceiver, receives a packet in which the deep packet information is tagged through the transceiver to parse the head room area, and switches the packet according to the deep packet information parsed in the head room area.

6. A packet processing method using a packet processing apparatus, comprising:
receiving a packet and transmitting the received packet to a packet inspection apparatus;
receiving a packet in which deep packet information is tagged in a head room area of the packet from the packet inspection apparatus and parsing the packet; and
switching the packet according to the parsed deep packet information.

7. The packet processing method of claim 6, further comprising distinguishing a general Ethernet packet and a tagged Ethernet packet based on information indicating whether a magic number and a checksum, which are inserted in the head room area along with the deep packet information, match each other.

8. A packet inspection method using a packet inspection apparatus, comprising:
receiving a packet from a packet processing apparatus;
performing deep-inspection on the received packet, and tagging deep packet information in a head room area of the packet; and
transmitting a packet in which the deep packet information is tagged to the packet processing apparatus.

9. The packet inspection method of claim 8, wherein the tagging includes inserting the magic number and the checksum in the head room area as a tag along with the deep packet information.
